(19) United States
(12) Patent Application Publication
(10) Pub. No.: US 2013/0117127 A1
(43) Pub. Date: May 9, 2013

(54) CONTEXTUAL AD STORIES

(71) Applicants: Sarah Jean Sosiak, San Francisco, CA (US); Steven Andrew McClelland, San Francisco, CA (US); Michael Metcalf, San Francisco, CA (US); Fernando Padilla, San Francisco, CA (US)

(72) Inventors: Sarah Jean Sosiak, San Francisco, CA (US); Steven Andrew McClelland, San Francisco, CA (US); Michael Metcalf, San Francisco, CA (US); Fernando Padilla, San Francisco, CA (US)

(73) Assignee: YAHOO! INC., Sunnyvale, CA (US)

(21) Appl. No.: 13/290,915

(22) Filed: Nov. 7, 2011

(51) Int. Cl. G06Q 30/02

(52) U.S. Cl. 705/14.66

(57) ABSTRACT

In one embodiment, a set of advertisements may be identified based, at least in part, upon a profile of a user. The set of advertisements may include a plurality of advertisements, where each of the plurality of advertisements corresponds to a different one of a plurality of contexts. A context of the user may be ascertained. One of the plurality of advertisements may be selected based, at least in part, upon the context of the user. The selected one of the plurality of advertisements may be provided.

### BACKGROUND OF THE INVENTION

The disclosed embodiments relate generally to methods and apparatus for advertising to users based, at least in part, upon the users' contexts.

Geo-targeting is the method of determining the geographical location of a website visitor and delivering different content to that visitor based on his or her location, such as country region/state, city, zip code, organization, Internet Protocol (IP) address, Internet Service Provider (ISP), or other criteria. A common usage of geo-targeting is found in online advertising. Therefore, geo-targeting delivers content to visitors based upon their current location.

### SUMMARY OF THE INVENTION

The disclosed embodiments enable advertisements to be provided to users based, at least in part, upon a context of the user. More particularly, multiple advertisements may be provided to users across multiple contexts. In this manner, a cohesive message may be provided to users receiving the advertisements.

In one embodiment, a set of advertisements may be identified based, at least in part, upon a profile of a user. The set of advertisements may include a plurality of advertisements, where each of the plurality of advertisements corresponds to a different one of a plurality of contexts. A context of the user may be ascertained. One of the plurality of advertisements may be selected based, at least in part, upon the context of the user. The selected one of the plurality of advertisements may then be provided to the user.

In accordance with another embodiment, a set of advertisements may be identified based, at least in part, upon a profile of a user, the set of advertisements including a plurality of advertisements that are related to one another, wherein each of the plurality of advertisements corresponds to a different one of a plurality of contexts. A first context of the user may be ascertained at a first time. A first one of the plurality of advertisements may then be provided to the user based, at least in part, upon the first context. A second context of the user may be ascertained at a second time. A second one of the plurality of advertisements may then be provided to the user based, at least in part, upon the second context.

In accordance with yet another embodiment, a context of a user may be ascertained. One of two or more sets of advertisements may be identified based, at least in part, upon a profile of the user and a first aspect of the context of the user, wherein each of the two or more sets of advertisements includes a plurality of advertisements and corresponds to a different value of the first aspect. One of the plurality of advertisements in the identified one of the two or more sets of advertisements may be selected. The selected one of the plurality of advertisements may then be provided.

In another embodiment, the invention pertains to a device comprising a processor, memory, and a display. The processor and memory are configured to perform one or more of the above described method operations. In another embodiment, the invention pertains to a computer readable storage medium having computer program instructions stored thereon that are arranged to perform one or more of the above described method operations.

These and other features and advantages of the present invention will be presented in more detail in the following specification of the invention and the accompanying figures which illustrate by way of example the principles of the invention.

### BRIEF DESCRIPTION OF THE DRAWINGS

FIG. 1 is a diagram illustrating an example system in which embodiments of the invention may be implemented.

FIGS. 2A-B are process flow diagrams illustrating example methods of implementing contextual advertisements in accordance with various embodiments.

FIG. 3 is a diagram illustrating a first example of a set of advertisements that may be provided across a plurality of contexts in accordance with various embodiments.

FIG. 4 is a process flow diagram illustrating another method of implementing contextual advertisements in accordance with various embodiments.

FIG. 5 is a diagram illustrating a second example including multiple sets of advertisements that may be implemented in accordance with various embodiments.

FIG. 6 is a diagram illustrating a third example including multiple sets of advertisements that may be implemented to tell a story in accordance with various embodiments.

FIG. 7 is a simplified diagram of an example network environment in which various embodiments may be implemented.

FIG. 8 illustrates an example computer system in which various embodiments may be implemented.

### DETAILED DESCRIPTION OF THE SPECIFIC EMBODIMENTS

Reference will now be made in detail to specific embodiments of the invention. Examples of these embodiments are illustrated in the accompanying drawings. While the invention will be described in conjunction with these specific embodiments, it will be understood that it is not intended to limit the invention to these embodiments. On the contrary, it is intended to cover alternatives, modifications, and equivalents as may be included within the spirit and scope of the invention as defined by the appended claims. In the following description, numerous specific details are set forth in order to provide a thorough understanding of the present invention. The present invention may be practiced without some or all of these specific details. In other instances, well known process operations have not been described in detail in order not to unnecessarily obscure the present invention.

Geo-targeting is typically used to select, create, transmit, and/or otherwise provide advertisements to website users based upon their current location. The current location of website users may be determined based upon location data that the users have explicitly and/or implicitly provided to the website. More particularly, the location data may be obtained from account data provided by the users during registration or as a result of updating the account data after registration has been completed. For example, the account data may include a registration zip code, home location (e.g., address or portion thereof), and/or work location (e.g., address or portion thereof). Therefore, the account data for a particular website user may identify one or more locations of the website user. The current location of the website user may also be identified based upon signals explicitly transmitted by the user or implicit signals. Examples of implicit signals include an IP address of the website user or Global Positioning System (GPS) location, which may be used to infer a current location, a home location, or a work location. As another example, the user's location may be implied through cell tower triangulation. A user may explicitly check in to a location via the use of a check in application, which may be accessed via a website and/or installed on a device such as a mobile device.

Geo-targeting may focus on location data explicitly or implicitly indicating the current location of the user. The assumption is that the user will likely take shopping action near the places they spend the most time: home and work. However, advertisements have not traditionally been provided to users based upon other contextual factors.

In accordance with the disclosed embodiments, a set of a plurality of advertisements may be stored in association with a plurality of contexts. Two or more advertisements in the set of advertisements may be provided to a user across two or more of the plurality of contexts. Through providing continuity of the advertising experience, a common advertising message shared by the plurality of advertisements may be strengthened. More particularly, advertisements may be identified, selected, generated, transmitted, and/or provided based, at least in part, upon a current context of a user. For example, the context of the user may indicate a time of day, a day of the week, a time of year (e.g., season, upcoming holidays, etc.), and/or weather conditions. The context may also indicate whether the user is in close proximity to one or more other individuals (e.g., whether the user is alone) and/or a level of attention of the user (e.g., whether the user is in transit or at home watching television).

In accordance with various embodiments, the context may also indicate a location of the user. The location may indicate a particular location (e.g., address) and/or geographic area (e.g., Hawaii). Similarly, the location may indicate whether the user is at work, at home, at the user's parent's home, on vacation, or traveling. In this manner, advertising opportunities may be identified when the user is in their Normal Geographic Area (NGA), as well as outside their NGA. Normal Geographic Areas include the user's home, work, school, etc. Areas outside of the NGA may include a parent's home, vacation locations, business travel, etc. Therefore, the disclosed embodiments may provide advertisers the opportunity to advertise to consumers based, at least in part, upon the consumers' location (e.g., work, home, vacation).

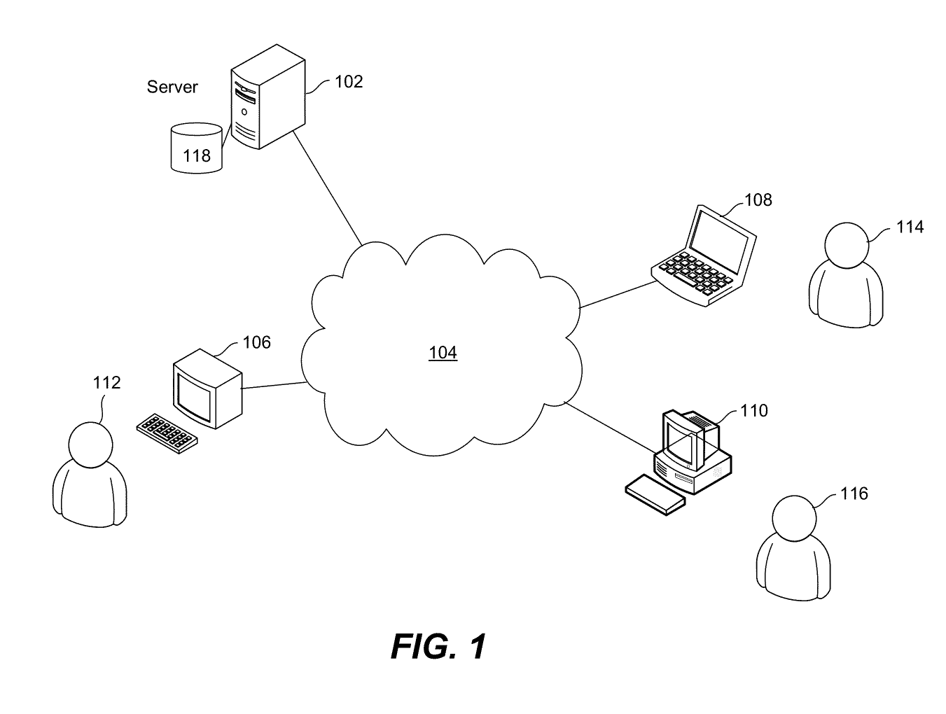

FIG. 1 is a diagram illustrating an example system in which embodiments of the invention may be implemented. As shown in FIG. 1, the system may include one or more servers 102 associated with a web site such as a social networking web site. Examples of social networking web sites include Yahoo, Facebook, Tumblr, LinkedIn, Flickr, and Meme. The server(s) 102 may enable the web site to provide a variety of services to its users. More particularly, users of the web site may maintain public user profiles, interact with other members of the web site, upload files (e.g., photographs, videos), etc.

In this example, the server(s) 102 may obtain or otherwise receive data (e.g., account data and/or user profile) and/or requests (e.g., search requests) via the Internet 104 from one or more computers 106, 108, 110 in association with corresponding clients, shown as entities 112, 114, 116, respectively. For example, each of the entities 112, 114, 116 may be an individual, a group of individuals (e.g., group, business or company), or other entity such as a web site. However, in order to simplify the description, the disclosed embodiments will be described with reference to individuals that are users of the web site.

As shown, the clients 112, 114, 116 may each receive an impression (i.e., view) of one or more advertisements upon accessing a web page via one of the servers 102. More particularly, an advertisement may be selected based, at least in part, upon the content of the web page. Alternatively, an advertisement may be transmitted to the clients 112, 114, 116 by one of the server(s) 102 via electronic mail, text message, or digital television. More particularly, advertisements may be transmitted via an ad server, which may be coupled to a web server. While a single server 102 is illustrated, it is important to note that the disclosed embodiments may be implemented via any number of servers.

The server(s) 102 may have access to one or more user logs 118 (e.g., user databases) into which user information is retained. This user information or a portion thereof may be referred to as a user profile. More particularly, the user profile may include public information that is available in a public profile and/or private information. The user logs 118 may be retained in one or more memories that are coupled to the server(s) 102.

The user information retained in the user logs 118 may include personal information such as demographic information (e.g., age and/or gender) and/or geographic information (e.g., residence address, work address, and/or zip code). In addition, each time a user performs online activities such as clicking on an advertisement or purchasing goods or services, information regarding such activity or activities may be retained as user data in the user logs 118. For instance, the user data that is retained in the user logs 118 may indicate the identity of web sites visited, identity of ads that have been selected (e.g., clicked on) and/or a timestamp. Moreover, where the online publisher supports a search engine via the server(s) 102, information associated with a search query, such as search term(s) of the search query, information indicating characteristics of search results that have been selected (e.g., clicked on) by the user, and/or associated timestamp may also be retained in the user logs 118. A user may be identified in the user logs 118 by a user ID (e.g., user account ID), information in a user cookie, etc.

An online publisher (i.e., web publisher) will generally be responsible for delivering multiple advertisements via the Internet (or other communication media such as email, text message, or digital television). A contract agreement associated with a particular advertisement may specify a minimum number of page views (i.e., impressions) to be delivered within a particular period of time. The web publisher is therefore responsible for providing the requested number of impressions for each advertisement.

An advertisement may include content pertaining to a product or service, which may be delivered via the Internet, email, text message, or digital television. The content typically includes text. However, it is important to note that an advertisement may include text, one or more images, video, and/or audio. An advertisement may also include one or more hypertext links, enabling a user to proceed with the purchase of a particular product or service.

The disclosed embodiments enable advertisements to be identified, selected, generated, transmitted, and/or otherwise provided to users based, at least in part, upon the users' context. More particularly, the server(s) 102 may provide advertisements to the users via the web site (e.g., via display on a web page of the web site), via electronic mail, Short Message Service (SMS), via a mobile device (e.g., text message), or via another medium such as digital television, which may be connected to the Internet.

Where an advertisement is provided to a particular user, information pertaining to the advertisement (e.g., identifying a product or service advertised in the advertisement) may be stored in association with the user's account data. In addition, the server(s) 102 may automatically collect online (and/or real world) behavioral data for any of users 112, 114, 116 to determine whether the advertisement was successful. In other words, the server(s) 102 may determine whether the user purchased the product or service advertised in the advertisement. Data indicating whether the advertisement was successful may also be stored in association with the user's account data and/or the advertisement.

In accordance with various embodiments, the system may store a set of advertisements, where the set of advertisements includes a plurality of advertisements, which may be associated with the same brand, product, service, and/or advertiser (e.g., a brand and any other partnered brand(s)). For example, the set of advertisements may pertain to Starbucks coffee. Each of the plurality of advertisements in the set of advertisements may correspond to a different one of a plurality of contexts.

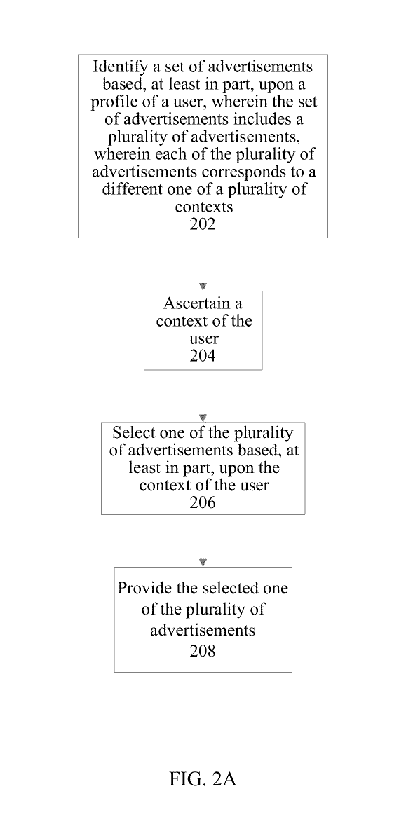

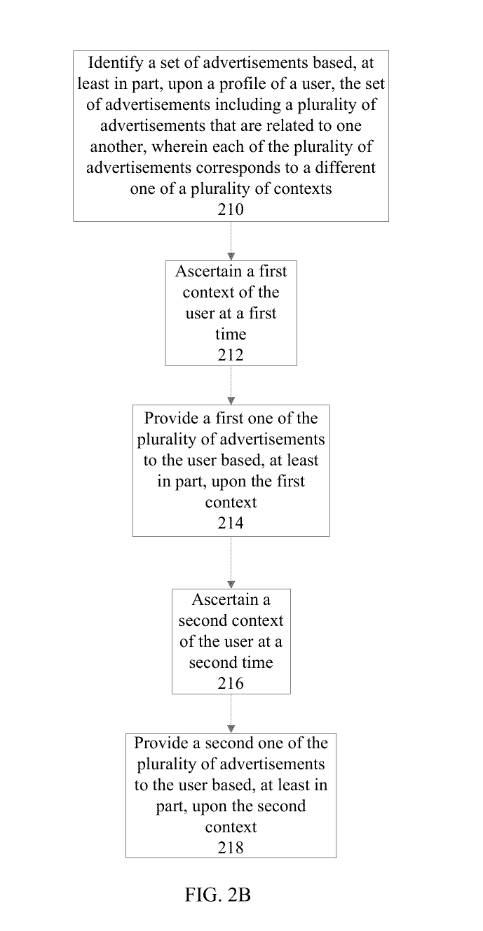

FIGS. 2A-B are process flow diagrams illustrating example methods of implementing contextual advertisements in accordance with various embodiments. As shown in FIG. 2A, the system may identify a set of advertisements at 202 based, at least in part, upon a profile of a user, the set of advertisements including a plurality of advertisements, wherein each of the plurality of advertisements corresponds to a different one of a plurality of contexts. For example, if the user's profile (e.g., interests and/or purchase history) indicates that the user likes coffee, the system may select a set of advertisements pertaining to Starbucks coffee. The system may ascertain a context of the user at 204. The system may store the context, or simply apply the context dynamically to select an advertisement to provide to the user. More particularly, the system may select one of the plurality of advertisements based, at least in part, upon the context of the user at 206. The system may then provide the selected one of the plurality of advertisements at 208.

The system may periodically ascertain a context of the user and provide an advertisement based, at least in part, upon the context of the user. For example, the context of the user may be ascertained after a pre-determined period of time has lapsed. As another example, the context of the user may be ascertained when a change in the context has been detected.

As shown in FIG. 2B, two or more advertisements in the set of advertisements may be provided to the user across two or more contexts. More particularly, a set of advertisements may be identified at 210 based, at least in part, upon a profile of a user, the set of advertisements including a plurality of advertisements, wherein each of the plurality of advertisements corresponds to a different one of a plurality of contexts. The system may periodically ascertain a context of the user. More particularly, a first context of the user may be ascertained at 212 at a first time. A first one of the plurality of advertisements may be provided to the user at 214 based, at least in part, upon the first context. A second context of the user may be ascertained at 216 at a second time. A second one of the plurality of advertisements may be provided to the user at 218 based, at least in part, upon the second context.

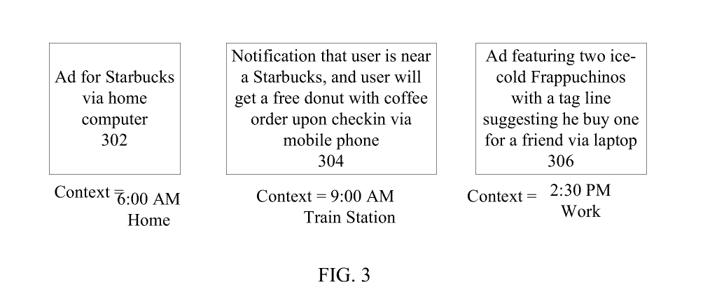

FIG. 3 is a diagram illustrating a first example of a set of advertisements (or portion thereof) that may be provided across a plurality of contexts in accordance with various embodiments. In this example, since the user's profile (e.g., interests and/or purchase history) indicates that the user likes coffee, the system may select or identify a set of advertisements pertaining to Starbucks coffee. In order to simplify this example, the advertisements provided to the user include three advertisements, where the advertisements are provided to the user across three different contexts.

As shown in this example, the context may indicate a device via which the selected one of the plurality of advertisements is to be provided (e.g., transmitted). For example, when the context indicates that it is 6:00 AM in the morning and the user is at home, this may indicate that the selected advertisement should be provided via the user's home computer. For example, an advertisement 302 for Starbucks may be provided to the user via the user's home computer. When the user's context indicates that it is 9:00 AM in the morning and the system detects that the user is in a particular train station, an advertisement 304 may be provided to the user in the form of a notification that the user is near a Starbucks. More particularly, the advertisement 304 may provide a particular location of the Starbucks. Since the context indicates that the user is in transit, the advertisement 304 may be transmitted to the user via the user's mobile phone via text message. Moreover, since the time is close to breakfast time, the advertisement 304 may also indicate that the user will get a free donut with a coffee order upon check in via their mobile device. The desire for a coffee first initiated by the earlier advertisement 302 may therefore be strengthened. Upon check in at Starbucks, the system may record the presence of the user at the Starbucks location. In addition, any purchases made by the user may be recorded.

In the afternoon, the user may take a break from work and open his laptop to look for a mid-afternoon distraction. The context may indicate that it is the afternoon and the user is at work. In addition, the context may indicate that it is sunny outside and that one or more other individuals are in the vicinity of the user. For example, the system may determine that a co-worker of the user's and who is also a contact of the user on a social network is nearby. The system may then present the user with an advertisement 306 featuring two ice-cold Frappucinos with a tag line suggesting that the user buy one for a friend. Since the context indicates that the user is at work, the system may ascertain that the advertisement 306 should be provided via the user's work laptop.

The plurality of advertisements in a set of advertisements may together tell a story across the plurality of contexts. As a result, two or more of the plurality of advertisements that are provided to a user may also tell a cohesive story. For example, the advertisement 302 may show an individual leaving his home for work and driving to a Starbucks, while the advertisement 306 may display the same individual at work with a coworker. Therefore, an order may be associated with the each of the plurality of advertisements such that the plurality of advertisements (or subset thereof) together tell a cohesive story that will further engage the user receiving two or more of the advertisements.

In accordance with various embodiments, the system may store two or more different sets of advertisements. Each of the sets of advertisements may correspond to a different value of a particular context aspect (e.g., weather conditions or season). For example, a first set of advertisements may correspond to hot weather (or Summer), while a second set of advertisements may correspond to cold weather (or Winter). Each of the sets of advertisements may include a plurality of advertisements, and the sets of advertisements may be associated with the same brand, product, service, and/or advertiser. For example, the sets of advertisements may each pertain to Starbucks coffee.

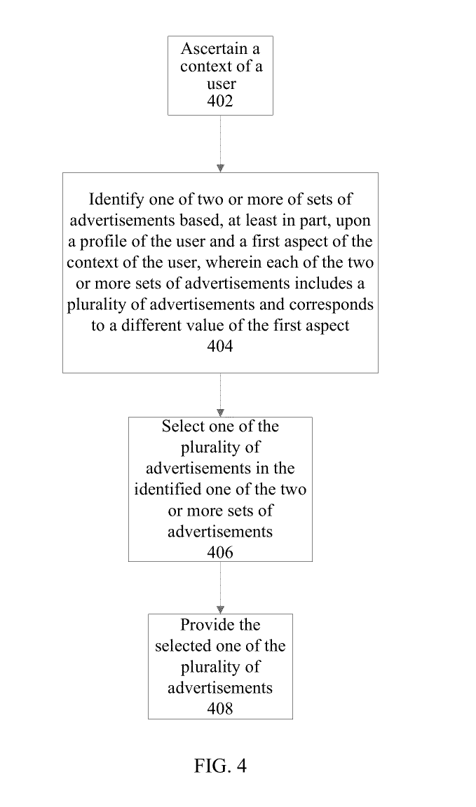

FIG. 4 is a process flow diagram illustrating another method of implementing contextual advertisements in accordance with various embodiments. As shown in FIG. 4, the system may ascertain a context of a user at 402. The system may then identify one of two or more sets of advertisements at 404 based, at least in part, upon a profile of the user and a first aspect of the context of the user, wherein each of the two or more sets of advertisements includes a plurality of advertisements and corresponds to a different value of the first aspect. For example, the identified set of advertisements may correspond to hot weather (e.g., where the first aspect is temperature). The system may select one of the plurality of advertisements in the identified one of the two or more sets of advertisements at 406. More particularly, the system may select one of the plurality of advertisements based, at least in part, upon the user's context (e.g., a value of at least a second aspect of the context). For example, one of the plurality of advertisements may be selected based, at least in part, upon a time of day. The system may then provide the selected one of the plurality of advertisements at 408.

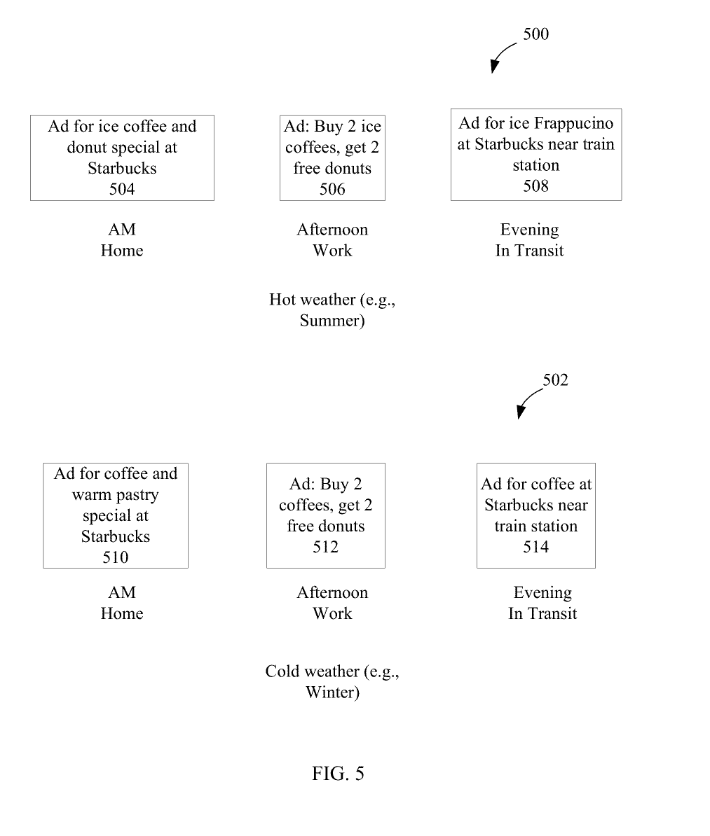

FIG. 5 is a diagram illustrating a second example including multiple sets of advertisements (or portions thereof) that may be implemented in accordance with various embodiments. In this example, we illustrate two different sets of advertisements (or portions thereof). We may assume that since the user's profile (e.g., interests and/or purchase history) indicate that the user likes coffee, the system identifies the sets of advertisements pertaining to Starbucks coffee. The system may further identify one of the sets of advertisements pertaining to an aspect of the user's context. For example, each set of advertisements in the sets of advertisements may correspond to a different type of weather or a different season. Therefore, an aspect of the user's context (e.g., weather conditions or season) may be ascertained in order to select the most pertinent one of the sets of advertisements.

As shown in this example, a first set of advertisements 500 may be associated with hot weather conditions or Summer, while a second set of advertisements 502 may be associated with cold weather conditions or Winter. Since it is currently summer and the weather is hot, the system may select the first set of advertisements 500. Based upon at least a second aspect of the user's context, the system may periodically select one of the advertisements 500 to provide to the user at various times during the day. In this example, when the context indicates that it is morning and the user is at home, a first advertisement 504 for an ice coffee and donut special at Starbucks may be provided to the user. For example, the first advertisement 504 may provided to the user via the user's home computer via a popup screen. Later in the day, when the context indicates that it is afternoon and the user is at work, the system may provide a second advertisement 506 to the user, where the advertisement notifies the user that if they buy two ice coffees, they receive two free donuts. For example, the second advertisement 506 may be provided to the user via an electronic mail or text message. When the system detects that it is evening and the user is in transit, the system may provide a third advertisement 508 to the user, where the third advertisement 508 reminds the user that they can order an ice Frappucino at a Starbucks that is proximate to the train station that they are approaching. Since the system knows that the user is in transit, the third advertisement 508 may be sent via text message to the user's mobile device.

The second set of advertisements 502 corresponding to cold weather may similarly be provided to the user throughout the day when the user detects that it is cold or the season is Winter. For example, in the morning when the user is at home, it may be assumed that the user is hungry. Therefore, the system may provide an advertisement 510 for coffee and a warm pastry special at Starbucks. During the afternoon when the user is at work and possibly in close proximity to other individuals, the system may provide an advertisement 512 informing the user that if the user buys two coffees at Starbucks, they may receive two free donuts. Later in the day, when the user is in transit, an advertisement 514 for Starbucks coffee may be sent to the user via text message, where the advertisement 514 informs the user that they are in close proximity to a Starbucks.

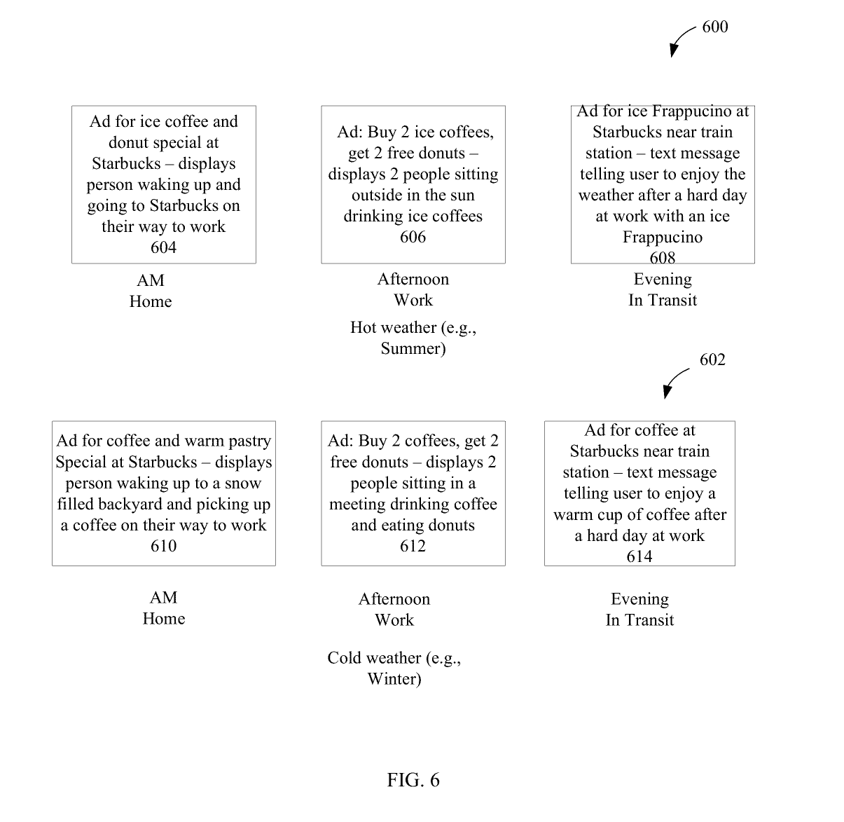

FIG. 6 is a diagram illustrating a third example including multiple sets of advertisements that may be implemented to tell a story in accordance with various embodiments. In this example, we illustrate two different sets of advertisements (or portions thereof). An order may be associated with the plurality of advertisements in each of the sets of advertisements such that the plurality of advertisements (or subset thereof that is ultimately provided to the user) together tells a story.

In accordance with various embodiments, the system may ascertain a current position of the user within the story. The system may then select one of the plurality of advertisements in one of the sets of advertisements based upon the current position of the user within the story. The system may increment the current position of the user within the story as the system provides advertisements to the user.

We may assume that since the user's profile (e.g., interests and/or purchase history) indicate that the user likes coffee, the system identifies the sets of advertisements pertaining to Starbucks coffee. The system may further identify one of the sets of advertisements pertaining to an aspect of the user's context. For example, each set of advertisements in the sets of advertisements may correspond to a different type of weather or a different season. Therefore, an aspect of the user's context (e.g., weather conditions or season) may be ascertained in order to select the most pertinent one of the sets of advertisements.

As shown in this example, a first set of advertisements 600 may be associated with hot weather conditions or Summer, while a second set of advertisements 602 may be associated with cold weather conditions or Winter. Since it is currently summer and the weather is hot, the system may select the first set of advertisements 600. Based upon at least a second aspect of the user's context, the system may periodically select one of the advertisements 600 to provide to the user at various times during the day.

When the context indicates that it is morning and the user is at home, a first advertisement 604 for an ice coffee and donut special at Starbucks may be provided to the user. More particularly, the first advertisement 604 may show a person waking up and going to Starbucks on their way to work. Since the user is at home, the first advertisement 604 may be provided to the user via their home computer via a popup screen.

Later in the day, when the context indicates that it is afternoon and the user is at work, the system may provide a second advertisement 606 to the user, where the advertisement notifies the user that if they buy two ice coffees, they receive two free donuts. More particularly, the second advertisement 606 may display two people sitting outside in the sun drinking ice coffees. For example, the second advertisement 606 may be provided to the user via the user's work laptop.

When the system detects that it is evening and the user is in transit, the system may provide a third advertisement 608 to the user, where the third advertisement 608 reminds the user that they can order an ice Frappucino at a Starbucks that is proximate to the train station that they are approaching. More particularly, the third advertisement 608 may tell the user to enjoy the weather after a hard day at work with an ice Frappucino. Since the system knows that the user is in transit, the third advertisement 608 may be sent via text message to the user's mobile device.

The second set of advertisements 602 corresponding to cold weather may similarly be provided to the user throughout the day when the user detects that it is cold or the season is Winter. For example, in the morning when the user is at home, it may be assumed that the user is hungry. Therefore, the system may provide an advertisement 610 for coffee and a warm pastry special at Starbucks. More particularly, the advertisement 610 may display a person waking up to a snow filled backyard and picking up a coffee on their way to work.

The system may provide one or more additional advertisements in the first set of advertisements 600 throughout the day. More particularly, during the afternoon when the user is at work and possibly in close proximity to other individuals, the system may provide an advertisement 612 informing the user that if the user buys two coffees at Starbucks, they may receive two free donuts. For example, the advertisement 612 may display two people sitting in a meeting drinking coffee and eating donuts. Later in the day, when the user is in transit, an advertisement 614 for Starbucks coffee may be sent to the user via text message, where the advertisement 614 informs the user that they are in close proximity to a Starbucks. For example, the advertisement 614 may tell the user to enjoy a warm cup of coffee after a hard day at work.

### Signals Indicating User Context

The system and/or device may periodically detect one or more aspects of the user's context. One or more aspects of the context may be captured based upon one or more signals (i.e., data). Each of the signals may be obtained from one or more data sources. Example signals will be described in further detail below.

The data that is obtained and/or analyzed may include one or more calendar entries of a user's electronic calendar. A calendar entry may include structured geographic information identifying or indicating a location of the user at a particular time. For example, calendar entries may identify a work meeting, work travel, vacation, sporting events, etc. This calendar information may also be used to infer whether the user is in close proximity to one or more other individuals, as well as a level of attention of the user. In addition, data may be obtained from a device's automated calendar and time functions. For example, the system may automatically determine a time of day, day of the week, season, or time of year (e.g., current or approaching holidays) from the device's calendar and time functions.

From the day of the week and time of day, the system may infer a location of the user. For example, on Monday at 11:00 AM, the system may infer that the user is at work, while on Saturday at noon, the system may infer that the user is not at work. Similarly, the user's IP address and/or GPS location may be used to ascertain the location of the user.

In addition, the data that is obtained and/or analyzed may identify one or events for which the user has purchased tickets. More particularly, an event may be identified based upon whether the user has clicked “Buy Ticket(s)” for the event. Events for which the user may purchase tickets may include sporting events, movies and/or theater productions. For example, if the user has purchased tickets for a baseball game and the system detects that the user is in a location proximate to the baseball park, the system may infer that the user is outside with one or more other individuals rather than inside alone.

Weather may be ascertained via a device or system thermometer. In addition, the weather in a particular location of the user may be ascertained via a weather application available on the Internet. Weather conditions may also be inferred based upon a system time and/or time of year according to the system/device calendar.

The system may also detect which device the user is using. For example, if the system detects browsing on a home laptop (or home computer), the system may infer that the user is at home. As another example, if the system detects that the user is changing channels via a digital television, the system may infer that the user is watching television. The system may then provide a selected advertisement to the user via the device being used by the user.

The system may also detect usage patterns associated with one or more devices. These usage patterns may be used to further infer or ascertain a level of attention of the user and/or activities being performed by the user. For example, when a user wakes up at 6 AM and checks the weather on his home computer, the system may determine based upon the time of day, usage patterns and activity on the user's home computer that the user just woke up. Therefore, the system may provide an advertisement triggering the user to stop at a local Starbucks on his way to work.

The system may ascertain a level of attention of the user based upon one or more data signals. More particularly, the system may infer a high level of attention of the user if the user is at home or at work. However, the system may infer a low level of attention if the user is in transit. For example, the system may determine based upon the user's schedule and/or movement of the GPS location of the user's mobile device that the user is in transit. If the user is watching television, the system may infer that the digital television is receiving a high level of attention from the user, while the user's laptop is receiving a low level of attention from the user. The system may apply the level of attention of the user to select an advertisement, determine a time to provide an advertisement, a device via which to provide an advertisement and/or advertising medium (e.g., text, electronic mail, web page and/or digital television).

In addition, the system may also determine whether the user is in close proximity to one or more other individuals based upon one or more data signals. This may be inferred based upon the user's schedule (e.g., patterns of the user and/or general patterns of individuals). For example, if the system detects that the user typically uses his work computer until 7:00 PM, the system may infer that the user works until that time and is using his work computer. As another example, the system may generally assume that individuals are at work until 5:30 PM. If the user is at work, the system may assume that the user is in close proximity to other individuals. In addition, the system may access one or more other applications, which may identify a current location of one or more contacts (e.g., friends) of the user, in order to determine whether the user is in close proximity to one or more other individuals.

Advertiser Interface

The system may provide one or more templates enabling advertisers to submit a set of a plurality of advertisements and associate the advertisements in the set with corresponding contexts. More particularly, the system may enable advertisers to successively select each of the advertisements and one of a plurality of contexts such that the system associates the selected advertisement with the selected context. For example, the system may provide advertisers with a plurality of contexts that are pre-configured to represent common contexts, where each of the plurality of contexts is defined by one or more possible context values. Alternatively, the advertisers may select each context by selecting one or more possible context values from a plurality of possible context values for each of one or more context aspects. In this manner, advertisers may submit advertising bids via the system such that each bid pertains to at least one context value of a context aspect.

The system may also provide templates for common contexts. More particularly, a template may enable advertisers to associate a plurality of advertisements that share a common context value for at least one context aspect. For example, a first template may be associated with hot weather, while a second template may be associated with cold weather.

Templates may also be provided for use in association with common story flows. For example, advertisers of laundry detergent may select a first story flow, while coffee shops or brands may select a second story flow. Story flows may also be associated with one or more particular context aspects and/or aspect value(s). For example, story flows associated with the day of the week and time of day context aspects may include a work day story flow and a weekend story flow. As another example, a story flow may be associated with hot weather, while another story flow may be associated with cold weather. A story flow may have a linear order, or may simply share a common theme.

In addition, the system may enable the advertisers to specify an order pertaining to the plurality of advertisements in a set such that the advertisements are ordered with respect to one another. In response, the system may assign the order to the plurality of advertisements. In this manner, the plurality of advertisements may tell a story across a plurality of contexts.

The system may store context information indicating one or more aspects of the context for each of a plurality of users. This context information may be analyzed to further determine which aspect(s) of the user's context are most useful in the selection of an advertisement. In addition, the system may assign a weight to each of the context aspects, which may be used to establish a price to charge advertisers. The context information may also be provided to advertisers to enable the advertisers to bid on various users and/or contexts (or one or more context aspects). For example, an advertiser who sells Starbucks coffee may be most interested in selling advertising when the weather is cold.

The price that an advertiser is charged for providing an advertisement of the advertiser may be based upon one or more factors. More particularly, the price that an advertiser is charged may depend, at least in part, upon the value of the context aspect(s) on which the advertiser bid. The value of a context aspect on which the advertiser bid may include a single numerical value or a range of numerical values. Thus, the advertiser may be charged more to advertise to users living in colder climates. The price may be ascertained through the use of a look up table or through the use of a calculation that is based, at least in part, upon the value of the context aspect(s) on which the advertiser bid. Moreover, the price that the advertiser is charged may depend, at least in part, upon a value of the context of the user receiving the advertisement. For example, where an advertiser bids on a temperature range of 30-60 degrees, a user context of 30 degrees may be assigned a greater value than a user context of 60 degrees.

The system may determine the effectiveness of the advertisement based upon whether the user purchased the product or service advertised to the user. For example, the system may ascertain whether the user visited a location or business that was advertised in the advertisement. This may be accomplished by ascertaining whether the user checked in to the location or business via a mobile device, or through other mechanisms. From this information, it is possible to determine whether the advertisement was effective in influencing future user behavior. This determination may be used to further tune the ability of the system to select an appropriate advertisement to provide to a user under various circumstances. Furthermore, this determination may be used to determine whether to provide further advertisements to the user. This determination may also be reported back to the advertiser.

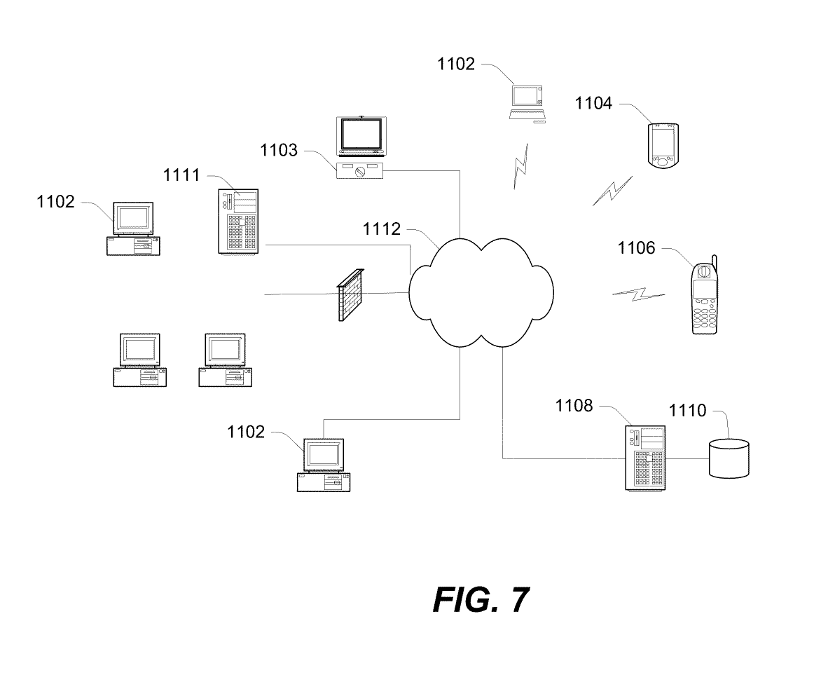

The disclosed embodiments may be implemented in any of a wide variety of computing contexts. For example, as illustrated in FIG. 7, implementations are contemplated in which users interact with a diverse network environment via any type of computer (e.g., desktop, laptop, tablet, etc.) 1102, media computing platforms 1103 (e.g., cable and satellite set top boxes and digital video recorders), handheld computing devices (e.g., PDAs) 1104, cell phones 1106, or any other type of computing or communication platform.

And according to various embodiments, input that is processed in accordance with the invention may be obtained using a wide variety of techniques. For example, input for may be obtained via a graphical user interface from a user's interaction with a local application such as a mobile application on a mobile device, web site or web-based application or service and may be accomplished using any of a variety of well-known mechanisms for obtaining information from a user. However, it should be understood that such methods of obtaining input from a user are merely examples and that input for generating a custom badge may be obtained in many other ways.

User context may be detected and implemented to facilitate advertising according to the disclosed embodiments in some centralized manner. This is represented in FIG. 7 by server 1108 and data store 1110 which, as will be understood, may correspond to multiple distributed devices and data stores. The data store 1110 may store user account data and/or preferences, user context, advertisements, and/or advertising bids. The invention may also be practiced in a wide variety of network environments (represented by network 1112) including, for example, TCP/IP-based networks, telecommunications networks, wireless networks, etc. In addition, the computer program instructions with which embodiments of the invention are implemented may be stored in any type of computer-readable media, and may be executed according to a variety of computing models including a client/server model, a peer-to-peer model, on a stand-alone computing device, or according to a distributed computing model in which various of the functionalities described herein may be effected or employed at different locations.

The disclosed techniques of the present invention may be implemented in any suitable combination of software and/or hardware system, such as a web-based server or desktop computer system. Moreover, a system implementing various embodiments of the invention may be a portable device, such as a laptop or cell phone. The apparatus and/or web browser of this invention may be specially constructed for the required purposes, or it may be a general-purpose computer selectively activated or reconfigured by a computer program and/or data structure stored in the computer. The processes presented herein are not inherently related to any particular computer or other apparatus. In particular, various general-purpose machines may be used with programs written in accordance with the teachings herein, or it may be more convenient to construct a more specialized apparatus to perform the disclosed method steps.

Regardless of the system's configuration, it may employ one or more memories or memory modules configured to store data, program instructions for the general-purpose processing operations and/or the inventive techniques described herein. The program instructions may control the operation of an operating system and/or one or more applications, for example. The memory or memories may also be configured to store instructions for performing the disclosed methods, graphical user interfaces to be displayed in association with the disclosed methods, detecting user context, facilitating advertiser bidding, and/or providing context information to advertisers, etc.

Because such information and program instructions may be employed to implement the systems/methods described herein, the present invention relates to machine readable media that include program instructions, state information, etc. for performing various operations described herein. Examples of machine-readable media include, but are not limited to, magnetic media such as hard disks, floppy disks, and magnetic tape; optical media such as CD-ROM disks; magneto-optical media such as floptical disks; and hardware devices that are specially configured to store and perform program instructions, such as read-only memory devices (ROM) and random access memory (RAM). Examples of program instructions include both machine code, such as produced by a compiler, and files containing higher level code that may be executed by the computer using an interpreter.

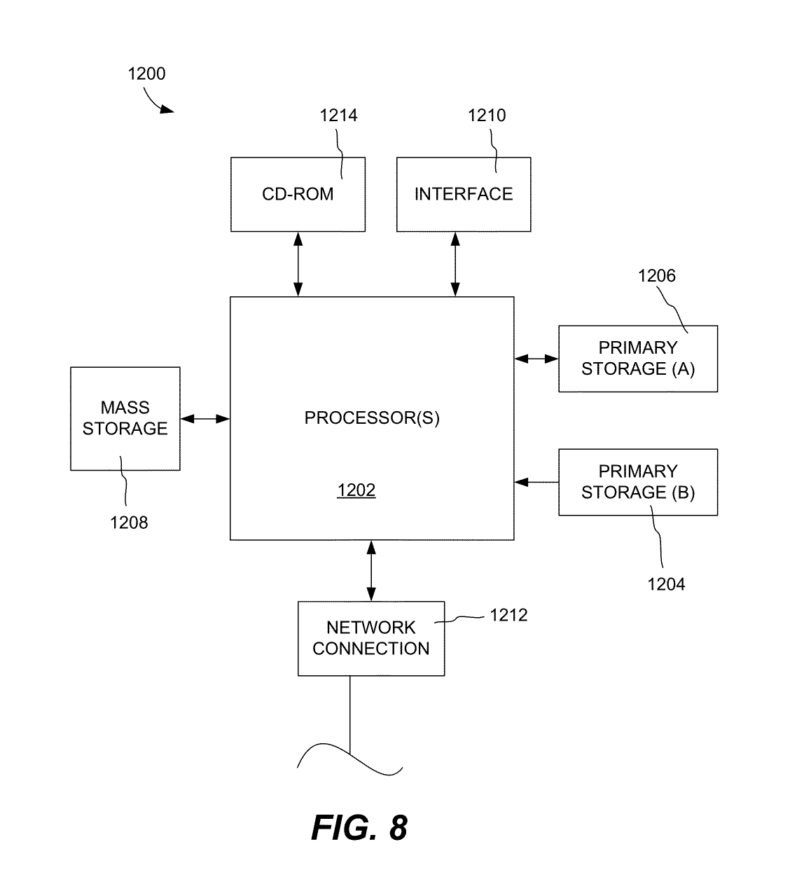

FIG. 8 illustrates a typical computer system that, when appropriately configured or designed, can serve as a system of this invention. The computer system 1200 includes any number of processors 1202 (also referred to as central processing units, or CPUs) that are coupled to storage devices including primary storage 1206 (typically a random access memory, or RAM), primary storage 1204 (typically a read only memory, or ROM). CPU 1202 may be of various types including microcontrollers and microprocessors such as programmable devices (e.g., CPLDs and FPGAs) and unprogrammable devices such as gate array ASICs or general purpose microprocessors. As is well known in the art, primary storage 1204 acts to transfer data and instructions uni-directionally to the CPU and primary storage 1206 is used typically to transfer data and instructions in a bi-directional manner. Both of these primary storage devices may include any suitable computer-readable media such as those described above. A mass storage device 1208 is also coupled bi-directionally to CPU 1202 and provides additional data storage capacity and may include any of the computer-readable media described above. Mass storage device 1208 may be used to store programs, data and the like and is typically a secondary storage medium such as a hard disk. It will be appreciated that the information retained within the mass storage device 1208, may, in appropriate cases, be incorporated in standard fashion as part of primary storage 1206 as virtual memory. A specific mass storage device such as a CD-ROM 1214 may also pass data uni-directionally to the CPU.

CPU 1202 may also be coupled to an interface 1210 that connects to one or more input/output devices such as such as video monitors, track balls, mice, keyboards, microphones, touch-sensitive displays, transducer card readers, magnetic or paper tape readers, tablets, styluses, voice or handwriting recognizers, or other well-known input devices such as, of course, other computers. Finally, CPU 1202 optionally may be coupled to an external device such as a database or a computer or telecommunications network using an external connection as shown generally at 1212. With such a connection, it is contemplated that the CPU might receive information from the network, or might output information to the network in the course of performing the method steps described herein.

Although the foregoing invention has been described in some detail for purposes of clarity of understanding, it will be apparent that certain changes and modifications may be practiced within the scope of the appended claims. Therefore, the present embodiments are to be considered as illustrative and not restrictive and the invention is not to be limited to the details given herein, but may be modified within the scope and equivalents of the appended claims.

What is claimed is:

1. A method, comprising:
identifying a set of advertisements based, at least in part, upon a profile of a user, the set of advertisements including a plurality of advertisements, wherein each of the plurality of advertisements corresponds to a different one of a plurality of contexts;
ascertaining a context of the user;
selecting one of the plurality of advertisements based, at least in part, upon the context of the user; and
providing the selected one of the plurality of advertisements.

2. The method as recited in claim 1, wherein the context indicates at least one of a time of day, a day of the week, a time of year, season, weather conditions, or a location of the user.

3. The method as recited in claim 1, wherein the context indicates a device via which the selected one of the plurality of advertisements is to be provided, wherein providing the selected one of the plurality of advertisements comprises:
transmitting the selected one of the plurality of advertisements via the device.

4. The method as recited in claim 1, wherein the context indicates whether the user is in close proximity to one or more other individuals or indicates a level of attention of the user.

5. The method as recited in claim 1, wherein the plurality of advertisements pertain to a single brand, product, service, advertiser, or advertising message.

6. The method as recited in claim 1, wherein the plurality of advertisements together tell a story across the plurality of contexts.

7. The method as recited in claim 1, wherein an order is associated with the plurality of advertisements such that the plurality of advertisements together tell a story.

8. The method as recited in claim 1, further comprising:
receiving a selection of one of the plurality of advertisements;
receiving a selection of one of a plurality of contexts;
associating the selected one of the plurality of advertisements with the selected one of the plurality of contexts.

9. The method as recited in claim 1, further comprising:
receiving an order pertaining to the plurality of advertisements such that each of the plurality of advertisements is ordered with respect to one another; and
assigning the order to the plurality of advertisements such that the plurality of advertisements tells a story across a plurality of contexts.

10. An apparatus, comprising:
a processor; and
a memory, at least one of the processor or the memory being adapted for:
ascertaining a context of a user;
identifying one of two or more sets of advertisements based, at least in part, upon a profile of the user and a first aspect of the context of the user, wherein each of the two or more sets of advertisements includes a plurality of advertisements and corresponds to a different value of the first aspect;
selecting one of the plurality of advertisements in the identified one of the two or more sets of advertisements; and
providing the selected one of the plurality of advertisements.

12. The apparatus as recited in claim 10, wherein selecting one of the plurality of advertisements is based upon at least a second aspect of the context of the user

13. The apparatus as recited in claim 10, wherein an order is associated with the plurality of advertisements in each of the plurality of sets of advertisements such that the plurality of advertisements together tells a story.

14. The apparatus as recited in claim 10, wherein each of the two or more sets of advertisements tells a story, at least one of the processor or the memory being further adapted for:
ascertaining a current position of the user within the story;
wherein selecting one of the plurality of advertisements in the identified one of the two or more sets of advertisements is performed based upon the current position of the user within the story; and
incrementing the current position of the user within the story.

15. The apparatus as recited in claim 10, wherein the context indicates at least one of a time of day, a day of the week, a time of year, season, weather conditions, a location of the user, whether the user is in close proximity to one or more other individuals, or a level of attention of the user.

16. The apparatus as recited in claim 10, wherein the context indicates a device via which the selected one of the plurality of advertisements is to be provided.

17. The apparatus as recited in claim 10, wherein the two or more sets of advertisements pertain to a single brand, product, or service.

17. The apparatus as recited in claim 10, wherein the two or more sets of advertisements are associated with a single advertiser.

18. A computer-readable medium storing thereon computer-readable instructions, comprising:
instructions for identifying a set of advertisements based, at least in part, upon a profile of a user, the set of advertisements including a plurality of advertisements, wherein each of the plurality of advertisements corresponds to a different one of a plurality of contexts;
instructions for ascertaining a first context of the user at a first time;
instructions for providing a first one of the plurality of advertisements to the user based, at least in part, upon the first context;
instructions for ascertaining a second context of the user at a second time; and
instructions for providing a second one of the plurality of advertisements to the user based, at least in part, upon the second context.

19. The computer-readable medium as recited in claim 18, further comprising:
instructions for ascertaining an amount to charge an advertiser for providing the first one of the plurality of advertisements based, at least in part, upon a value of the first context pertaining to a bid of the advertiser.

20. The computer-readable medium as recited in claim 18, further comprising:
instructions for obtaining a bid from an advertiser, the bid pertaining to at least one context value.
